(19) United States
(12) Patent Application Publication
(10) Pub. No.: US 2025/0299398 A1
(43) Pub. Date: Sep. 25, 2025

(54) MAP EDITING METHOD, ELECTRONIC DEVICE, AND STORAGE MEDIUM

(71) Applicant: Beijing Youzhuju Network Technology Co., Ltd., Beijing (CN)

(72) Inventor: Hongxiang SHU, Beijing (CN)

(21) Appl. No.: 19/034,496

(22) Filed: Jan. 22, 2025

(30) Foreign Application Priority Data
Mar. 21, 2024 (CN) 202410330757.0

(51) Int. Cl. G06T 11/60

(52) U.S. Cl. CPC G06T 11/60; G06T 2200/24; G06T 2210/62

(57) ABSTRACT

Embodiments of the present disclosure provide a map editing method, an electronic device, and a storage medium. The method includes: displaying a map to be edited in response to a map display operation; converting a grid map corresponding to the map to be edited into an image to be edited in a preset format in response to a trigger operation for a target control; determining, in response to an editing operation for the image to be edited, an editing region of the editing operation in the map to be edited; and determining a target map corresponding to the map to be edited based on editing information of each grid in the editing region. The technical solutions provided in the embodiments of the present disclosure achieve a technical effect of editing a local map.

The application claims priority to Chinese patent application No. 202410330757.0, filed on Mar. 21, 2024, the entire disclosure of which is incorporated herein by reference as part of the present application.

### TECHNICAL FIELD

Embodiments of the present disclosure relate to the field of data processing technology, and in particular, to a map editing method and apparatus, an electronic device, and a storage medium.

### BACKGROUND

When map editing is performed based on a map editor, optionally, the map editing includes performing an operation of creating a map or modifying a map content. The entire map needs to be arranged at a predetermined grid size, and modified map data is obtained by editing each grid.

In a scenario in which a map has a large area, that is, the map has a large quantity of grids, tens of thousands of grids need to be rendered at one time, which exceeds an upper performance limit of a graphics drawing tool used by an editor or a browser, resulting in system crash, lag, and the like in an editing process, and thus causing a problem that map data cannot be effectively edited.

### SUMMARY

The present disclosure provides a map editing method and apparatus, an electronic device, and a storage medium, to achieve an effect of effectively and efficiently editing map data without increasing costs.

According to a first aspect, an embodiment of the present disclosure provides a map editing method. The method includes:
displaying a map to be edited in response to a map display operation;
converting a grid map corresponding to the map to be edited into an image to be edited in a preset format in response to a trigger operation for a target control;
determining, in response to an editing operation for the image to be edited, an editing region of the editing operation in the map to be edited; and
determining a target map corresponding to the map to be edited based on editing information of each grid in the editing region.

According to a second aspect, an embodiment of the present disclosure further provides a map editing apparatus. The apparatus includes:
a map-to-be-edited display module configured to display a map to be edited in response to a map display operation;
an image-to-be-edited display module configured to convert a grid map corresponding to the map to be edited into an image to be edited in a preset format in response to a trigger operation for a target control;
an editing region determination module configured to determine, in response to an editing operation for the image to be edited, an editing region of the editing operation in the map to be edited; and
a target map determination module configured to determine a target map corresponding to the map to be edited based on editing information of each grid in the editing region.

According to a third aspect, an embodiment of the present disclosure further provides an electronic device. The electronic device includes:
one or more processors; and
a storage apparatus configured to store one or more programs; and
the one or more programs, upon being executed by the one or more processors, the map editing method described in any one of the embodiments of the present invention is implemented by the one or more processors.

According to a fourth aspect, an embodiment of the present disclosure further provides a storage medium containing computer-executable instructions that, when executed by a computer processor, are used to perform the map editing method described in any one of the embodiments of the present invention.

In the technical solutions provided in the embodiments of the present disclosure, the map to be edited may be displayed in response to the map display operation; if triggering of displaying the image to be edited corresponding to the map to be edited is detected, the grid map corresponding to the map to be edited may be converted into the image to be edited in the preset format; and the editing region in the map to be edited is determined based on a box selection operation performed on the image to be edited. Further, after the editing region is determined, grids in the editing region may be in an editable state, so that map data editing is performed on a corresponding grid, to obtain the target map in which map data changes. Therefore, a problem in the prior art that versatility of map data editing is poor because a requirement for performance of a graphics drawing tool is high in the case where a map has a large area and tens of thousands of grids need to be rendered at one time is resolved, only a local map in the map to be edited is edited, and the local map may be efficiently edited in the case where there is no requirement for performance of a browser or the graphics drawing tool.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a map editing method according to an embodiment of the present disclosure;

FIG. 2 is a schematic flowchart of a map editing method according to an embodiment of the present disclosure;

FIG. 3 is a schematic diagram of displaying full grids in a map to be edited according to an embodiment of the present disclosure;

FIG. 4 is a schematic diagram of displaying a grid map in a preset format according to an embodiment of the present disclosure;

FIG. 5 is a schematic diagram including an editing region according to an embodiment of the present disclosure;

FIG. 6 is a schematic diagram of a structure of a map editing apparatus according to an embodiment of the present disclosure; and

FIG. 7 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

Before the technical solutions provided in the embodiments of the present disclosure are described, an exemplary description may be given to the application scenario. An apparatus for performing a map editing method provided in the embodiments of the present disclosure may be integrated in application software supporting an interactive function, and the software may be installed in an electronic device. Optionally, the electronic device may be a mobile terminal, a PC terminal, etc. The application software may be software with an information editing function. Specific application software is not described in detail herein, provided that the information editing function can be implemented. The application software may alternatively be a specially developed application used for implementing an operation of editing map data.

It should be noted that the technical solutions provided in the embodiments of the present disclosure may be applied to content editing at a map data development stage, and may also be applied in a scenario in which the map data is completely or partially updated after the map data is generated. For specific implementations, refer to detailed description of the embodiments of the present disclosure.

It should be further noted that a corresponding application or editing interface may be developed based on the solutions provided in the embodiments of the present disclosure, or the solutions provided in the embodiments of the present disclosure may be integrated in any application or map data editor requiring modification of map data with map data changes.

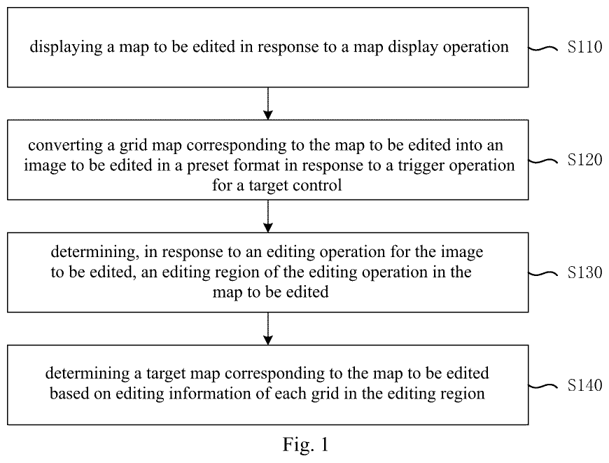

FIG. 1 is a schematic flowchart of a map editing method according to an embodiment of the present disclosure. The embodiments of the present disclosure are applicable to any scenario in which map data needs to be edited. The map editing method may be performed by a map editing apparatus. The map editing apparatus may be integrated in a computer device. Optionally, the computer device may include a PC terminal, a mobile terminal, etc.

As shown in FIG. 1, the method includes the following steps.

S110: displaying a map to be edited in response to a map display operation.

The map to be edited may be a map for which a map content needs to be edited. A plurality of maps may be pre-stored, such maps may be maps in use or maps that are pre-created but not yet in use. A map matching the map display operation is used as the map to be edited. It can be understood that any map that needs to be edited may be triggered and selected from a plurality of maps as the map to be edited. Alternatively, an identifier corresponding to each map may be preset, and a corresponding map is retrieved as the map to be edited based on the edited content in a corresponding edit box. Optionally, the edited content may be an identifier of the map.

Specifically, in response to that triggering of a specific map is detected and it is determined to perform editing, it indicates that the map display operation is triggered. In this case, the triggered and selected map may be used as the map to be edited and the map to be edited is displayed. Alternatively, an identifier of a map that needs to be edited is filled in a map-to-be-edited selection control, and after the filling of the identifier is completed and a confirm control is clicked, a corresponding map to be edited may be retrieved and displayed based on the identifier of the map.

It should be further noted that grids corresponding to the map to be edited may be displayed when the map to be edited is displayed, at the same time, grid data corresponding to each grid may be recorded. The grid data may include information such as whether the grid is passable or a wait point, and so on.

S120: converting a grid map corresponding to the map to be edited into an image to be edited in a preset format in response to a trigger operation for a target control.

The target control may be a control for converting the map to be edited into the image to be edited. A full grid map corresponding to the map to be edited may be converted into an image in a picture format, and the converted image is used as the image to be edited. The preset format may be a picture format, optionally, such as a png format, a jpg format, etc. The grid map is an image that is consistent with the map to be edited and is represented in a grid form, and each grid is used to record the data content corresponding to the point.

Specifically, in response to that triggering of the target control is detected, the full grid map corresponding to the map to be edited may be converted into the image to be edited in the picture format.

In other words, a corresponding grid map may be created based on the map to be edited, to convert the grid map into the preset format to obtain a background image of the image to be edited. A benefit of such a setting is that a problem in the prior art that a requirement for performance of drawing software is high because all grids need to be rendered, in the case where data of only one grid is updated, is avoided. After the grid map is converted into the background image, an editing region corresponding to an editing operation of a user may be determined based on the editing operation, to process grid data in the editing region, thereby achieving an effect of processing only a part of the grid data.

S130: determining, in response to an editing operation for the image to be edited, an editing region of the editing operation in the map to be edited.

The editing operation can be understood as an operation of performing box selection, in the image to be edited, on a region that needs to be edited. Optionally, box selection is performed in the image to be edited based on a graphics drawing tool to obtain a box-selected region, and the selected box-selected region is used as the editing region.

Specifically, a box selection tool is triggered and selected, the box selection tool is controlled based on a mouse to select the box-selected region from the image to be edited, and the selected box-selected region is used as the editing region. In other words, the editing region is a partial region in the map to be edited, so that an effect of editing a local map is achieved. That is, only the local map needs to be edited. Accordingly, only grids corresponding to a part of the map need to be rendered, thereby greatly lowering a requirement for performance of a browser or the graphics drawing tool.

S140: determining a target map corresponding to the map to be edited based on editing information of each grid in the editing region.

After the editing region is determined, grids corresponding to the editing region may be retrieved, and each grid is edited, to obtain grid data corresponding to each grid. After editing of each grid is completed, the grids may be rendered to obtain a region map corresponding to the editing region, and the map to be edited may be updated based on the region map, to obtain the target map after the editing region is edited.

It can be learned from the above description that in the solutions provided in this embodiment of the present disclosure, a problem that a data volume of a graph to be rendered is excessively large and may exceed an upper limit of the browser or the used graphics drawing tool can be dealt with, that is, the map data is processed by using a local map editing method, thereby improving efficiency of local editing of the map without increasing costs.

In the technical solutions provided in the embodiments of the present disclosure, the map to be edited may be displayed in response to the map display operation; if triggering of displaying the image to be edited corresponding to the map to be edited is detected, the grid map corresponding to the map to be edited may be converted into the image to be edited in the preset format; and the editing region in the map to be edited is determined based on a box selection operation performed on the image to be edited. Further, after the editing region is determined, the grids in the editing region may be in an editable state, so that map data editing is performed on a corresponding grid, to obtain the target map in which the map data changes. Therefore, a problem in the prior art that versatility of map data editing is poor because a requirement for performance of a graphics drawing tool is high in the case that a map has a large area and tens of thousands of grids need to be rendered at one time is resolved, only the local map in the map to be edited is edited, and the local map may be efficiently edited in the case that there is no requirement for performance of the browser or the graphics drawing tool.

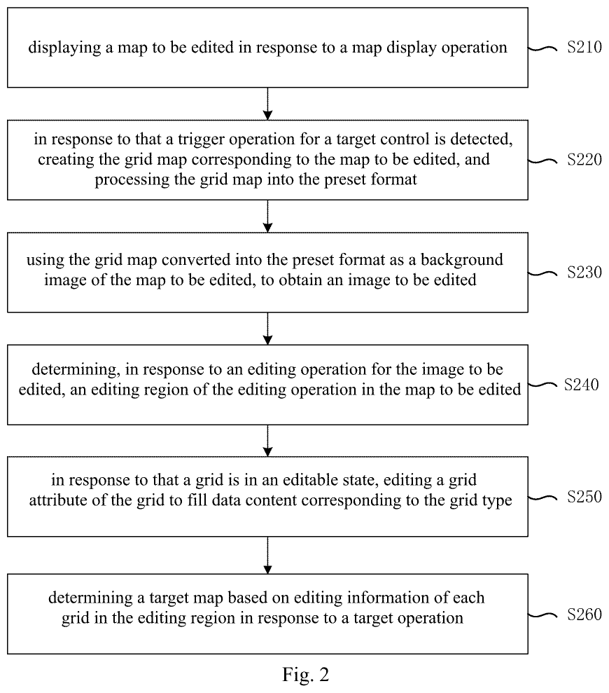

FIG. 2 is a schematic flowchart of a map editing method according to an embodiment of the present disclosure. On the basis of the above embodiment, the step of converting the grid map corresponding to the map to be edited into the image to be edited in the preset format in response to the trigger operation for the target control may be further detailed. For specific implementations, refer to detailed description of the embodiments of the present disclosure. Technical terms the same as or corresponding to those in the above embodiment are not described in this embodiment.

As shown in FIG. 2, the method includes the following steps.

S210: displaying a map to be edited in response to a map display operation.

It can be understood as that a corresponding map to be edited may be displayed after triggering of a map display control is detected.

S220: in response to that a trigger operation for a target control is detected, creating the grid map corresponding to the map to be edited, and processing the grid map into the preset format.

It should be noted that after the map to be edited is displayed, if triggering of the target control is detected, the grid map corresponding to the map to be edited may be displayed, that is, grid information is added to the map to be edited and an obtained map is used as the grid map. Refer to FIG. 3. The grid map corresponding to the map to be edited may be displayed. The grid map includes a plurality of grids, and grid attributes of the grids may be the same or different. Whether the grid attributes of the grids are the same adapts to a specific application scenario of the map to be edited. The grid attribute may include a grid type of the grid. Optionally, the grid type may include a passable type, a non-passable type, a wait point type, a non-wait point type, etc. In other words, the grid type is a passable state or a state of whether the grid is a wait point that corresponds to each grid.

It should be further noted that the full grids corresponding to the map to be edited may be displayed before local editing is performed on the map to be edited, that is, an image including all current grids may be completely displayed first, as shown in FIG. 3. To specifically create and edit the grids of a local region subsequently, after all the grids may be drawn by using a 2D rendering library to display the full grids, and then all the grids are converted into a picture in the preset format.

Specifically, in response to that triggering of an image editing control (the target control) is detected, full grids corresponding to the image to be edited may be created, that is, the grid map is created. At the same time, to help achieve an effect of editing a local map subsequently, the grid map may be converted into the preset format. In this case, the preset format may be a picture format. After the grid map is converted into the picture format, an image converted into the preset format may be displayed.

S230: using the grid map converted into the preset format as a background image of the map to be edited, to obtain an image to be edited.

The image converted into the preset format is used as the grid map. The grid map may be used as the background image. The map data is used as a foreground image, and the image to be edited is determined based on the background image and the foreground image.

For example, the converted grid map may be used as the background image and inserted into an image editor. A benefit of such a setting is that all the grids may be displayed in full, and a local region may be further box-selected based on the background image to create grids for editing.

It should be further noted that in the case where there is rendering processing that requires high performance and in which more than 100000 grids may need to be rendered and converted into png, a 2D rendering library may be used. The 2D rendering library enables a developer to harness the power of WebGL. For a browser that does not support WebGL, the 2D rendering library can automatically fall back to use canvas to always ensure optimal performance. In addition, a large quantity of same grid graphs are created by using a particle system of the 2D rendering library, thereby greatly improving processing efficiency. FIG. 3 shows an example of displaying nearly 20000 created grids in full. Borders of the grids may not be drawn on the background image to obviously distinguish editable grids, with only an effect of the grids covering the map displayed, as shown in FIG. 4.

On the basis of the above technical solutions, the method further includes: displaying the grid map based on a preset transparency, such that at least one grid in the grid map is in an invisible state.

The preset transparency is preset and is used to determine a transparency value in the case where the grid map is used as the background image.

It can be understood as that corresponding transparency may be set to use the grid map as the background image of the editor based on the transparency for display. A benefit of such a setting is that the grids in the grid map may be in the invisible state.

It should be noted that FIG. 3 and FIG. 4 merely show exemplary illustrations, where display information in green is used to represent that grids are in a passable state, and display information in gray is used to represent that grids are in a non-passable state.

S240: determining, in response to an editing operation for the image to be edited, an editing region of the editing operation in the map to be edited.

In this embodiment, the editing operation includes an operation of editing a region coordinate in a region selection control and/or an operation of performing box selection on the image to be edited based on a box selection tool, and determining the editing region of the editing operation in the map to be edited includes: determining a target position of the region coordinate in the map to be edited, and determining the editing region based on the target position; and/or using a start position of the box selection tool in the map to be edited as a first coordinate of the editing region, using an end position of the box selection tool in the map to be edited as a second coordinate of the editing region, and determining the editing region based on the first coordinate and the second coordinate.

It can be understood as that the editing operation includes at least two operation manners. The first operation manner may be the operation of editing the region coordinates in the region selection control, and the other operation manner is a manner of performing selection by using a mouse.

The two operation manners are described in detail below. Coordinate information of a region to be selected may be edited in the region selection control. Optionally, coordinates corresponding to each grid may be displayed in a display interface, so that a user edits corresponding coordinates in the region selection control. After editing is completed, a region may be determined based on the edited coordinates. The region determined in this case is used as the editing region. If the editing region is determined in the manner of performing selection by using the mouse, an event associated with the mouse may be monitored in real time. Optionally, in response to it is detected that the mouse triggers a box selection event, a start position of the mouse (the box selection tool) in the map to be edited may be used as the first coordinate of the editing region, and accordingly, an end position of the mouse (the box selection tool) in the map to be edited is used as the second coordinate of the editing region. A rectangular region may be determined based on the first coordinate and the second coordinate, and the rectangular region is used as the editing region.

After the editing region is determined, to achieve effects of visualization and ease of display, a box-selected region may be distinctly displayed in the map to be edited. In this embodiment, differential display may be determining and creating corresponding grids in the editing region after the editing region is box-selected. In this case, a corresponding grid may be displayed based on the grid attribute corresponding to each grid. After grid creation is completed, each grid in the editing region is in an editable state. In the case where the grid is in the editable state, an attribute of each grid may be edited, to achieve the effect of editing the local map.

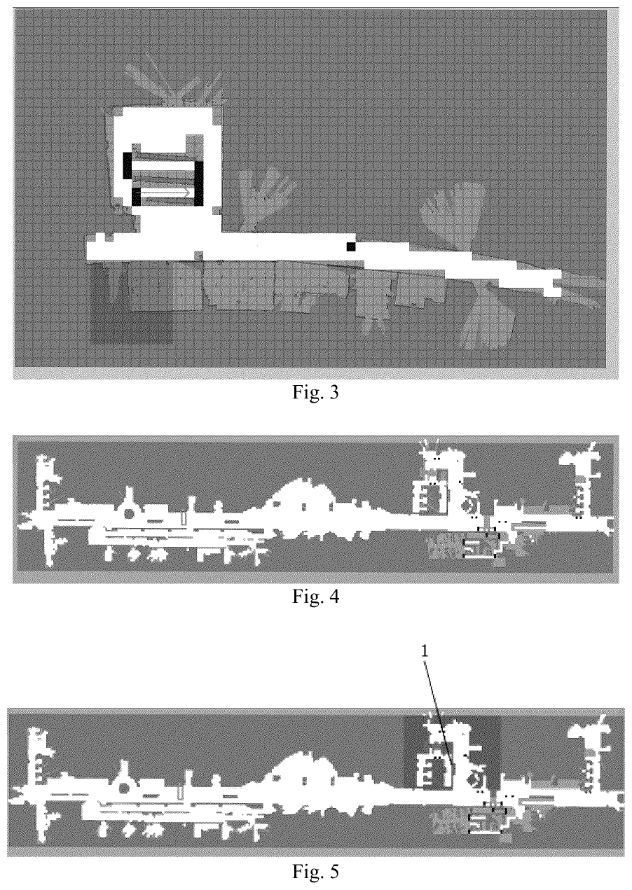

It can be understood that after the editing region is determined, the grids corresponding to the editing region may be created, distinctly displayed in the map to be edited, and adjusted to be in the editable state. Refer to a box-selected region 1 in FIG. 5, that is, an editing region 1. Accordingly, the editing region may include a plurality of grids in the editable state.

It should be further noted that a size of the grid in the editing region is the same as a size of the grid created corresponding to the map to be edited. Further, in this case, the created grids are determined from the grids corresponding to the map to be edited.

S250: in response to that a grid is in an editable state, editing a grid attribute of the grid to fill data content corresponding to the grid type.

It can be understood as that after the editing region is determined, at least one grid in the editing region is in the editable state. In this case, the grid attribute of each grid may be edited according to an actual requirement, to modify a grid attribute corresponding to a corresponding grid. After the modification is completed and a confirm control is clicked, the modified grid attribute may be used as data content of the corresponding grid.

S260: determining a target map based on editing information of each grid in the editing region in response to a target operation.

In practical application, there is a specific requirement for performance of each drawing software. Therefore, an upper processing limit may be set corresponding to the drawing software. Optionally, grid data of the editing region is determined to provide a message prompt in response to that a total number of grids reaches a preset quantity threshold.

It can be understood as that in a process of determining the editing region, a prompt may be provided based on a total number of grids corresponding to the box-selected region, to avoid an impact that data cannot be effectively aligned and processed because the quantity of grids in the selected editing region is excessively large.

It should be further noted that all the grids need to be rendered if full map data rendering processing is performed for the map to be edited, resulting in low rendering efficiency and a high requirement for performance of a device.

In the technical solutions provided in the embodiments of the present disclosure, the map to be edited may be displayed in response to the map display operation; if triggering of displaying the image to be edited corresponding to the map to be edited is detected, the grid map corresponding to the map to be edited may be converted into the image to be edited in the preset format; and the editing region in the map to be edited is determined based on a box selection operation performed on the image to be edited. Further, after the editing region is determined, the grids in the editing region may be in the editable state, so that map data editing is performed on a corresponding grid, to obtain the target map in which the map data changes. Therefore, a problem in the prior art that versatility of map data editing is poor because a requirement for performance of a graphics drawing tool is high in the case where a map has a large area and tens of thousands of grids need to be rendered at one time is resolved, only the local map in the map to be edited is edited, and the local map may be efficiently edited in the case where there is no requirement for performance of a browser or the graphics drawing tool.

On the basis of the above embodiment, it should be further noted that in a process of editing the grid data in the editing region, the grid data may be further stored to facilitate subsequent modification of the grid data. Grid information may be stored by using structured data. For specific implementations, refer to detailed description of the embodiments of the present disclosure. Technical terms the same as or corresponding to those in the above embodiment are not described in this embodiment.

It should be noted that after the grid map corresponding to the map to be edited is created in response to that triggering of the target control is detected, the method further includes: creating a hash table corresponding to the grid map. The grid map includes a plurality of grids, and a size of each grid is set according to an actual requirement, and certainly conforms to a layout of a corresponding region. The hash table may store a grid identifier of each grid and corresponding grid data of each grid.

It should be further noted that, for grid attributes, grid types in grid attributes corresponding to different grids are different, and a hash table corresponding to each grid type may be created. Optionally, the grid types may include a passable grid type, a non-passable grid type, a wait point grid type, and a non-wait point grid type. Corresponding hash tables may be created based on different grid types.

Further, linkage information between each grid in the grid map and grid data of a corresponding grid in at least one hash table may be established. In response to that it is detected that a grid attribute of a specific grid changes, data content corresponding to a corresponding grid may be modified in the hash table, to achieve a dynamic data update effect. Accordingly, if the data content of the grid in the hash table is modified, display information of a corresponding grid in the map data may also be modified.

It can be understood as that in a manner of performing local editing on the map to be edited, the grid data of the grid may be stored by using the structured data, to modify only the grid information in the local editing region. Certainly, to more efficiently process storage of local editing data, after full grid information is obtained, grid information lists with different meanings may be converted into hash tables, to improve search and replacement efficiency in the case where the grid information in the local editing region is finally traversed for storage. For example, in the case where the grid attribute of the grid is adjusted from the non-passable type to the passable type, an index value of the grid in a non-passable grid list may be directly queried in a non-passable hash table (in this case, the index value may be the grid identifier of the grid), and corresponding grid data is deleted based on the index value and is added to a hash table of a passable type.

In a manner of storing hash table information by using a memory, time complexity of searching is greatly reduced, and data search efficiency is improved.

In the technical solution provided in this embodiment of the present disclosure, in a process of editing the grid data, data storage may be performed based on the grid attribute of the grid, so that corresponding grid data can be searched from a corresponding data storage table when it is detected that the grid data is modified, thereby achieving an effect of effectively and efficiently updating the grid data.

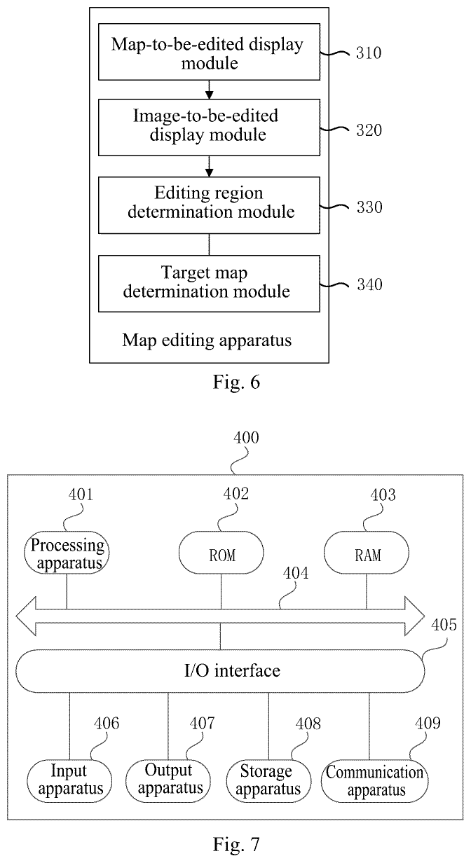

FIG. 6 is a schematic diagram of a structure of a map editing apparatus according to an embodiment of the present disclosure. As shown in FIG. 6, the apparatus includes: a map-to-be-edited display module 310, an image-to-be-edited display module 320, an editing region determination module 330, and a target map determination module 340.

The map-to-be-edited display module 310 is configured to display a map to be edited in response to a map display operation. The image-to-be-edited display module 320 is configured to convert a grid map corresponding to the map to be edited into an image to be edited in a preset format in response to a trigger operation for a target control. The editing region determination module 330 is configured to determine, in response to an editing operation for the image to be edited, an editing region of the editing operation in the map to be edited. The target map determination module 340 is configured to determine a target map corresponding to the map to be edited based on editing information of each grid in the editing region.

In the technical solutions provided in the embodiments of the present disclosure, the map to be edited may be displayed in response to the map display operation; if triggering of displaying the image to be edited corresponding to the map to be edited is detected, the grid map corresponding to the map to be edited may be converted into the image to be edited in the preset format; and the editing region in the map to be edited is determined based on a box selection operation performed on the image to be edited. Further, after the editing region is determined, grids in the editing region may be in an editable state, so that map data editing is performed on a corresponding grid, to obtain the target map in which map data changes. Therefore, a problem in the prior art that versatility of map data editing is poor because a requirement for performance of a graphics drawing tool is high in the case where a map has a large area and tens of thousands of grids need to be rendered at one time is resolved, only a local map in the map to be edited may be edited, and the local map is efficiently edited in the case where there is no requirement for performance of a browser or the graphics drawing tool.

On the basis of the above technical solutions, the image-to-be-edited display module includes:
an image conversion unit configured to, in response to that the trigger operation for the target control is detected, create the grid map corresponding to the map to be edited, and process the grid map into the preset format; and
an image-to-be-edited determination unit configured to use the grid map converted into the preset format as a background image of the map to be edited, to obtain the image to be edited.

On the basis of the above technical solutions, the grid map includes at least one grid, and a grid attribute of the at least one grid includes a grid type of the grid.

On the basis of the above technical solutions, the apparatus further includes: a state update module configured to display the grid map based on a preset transparency, such that the at least one grid in the grid map is in an invisible state.

On the basis of the above technical solutions, the editing operation includes an operation of editing region coordinates in a region selection control and/or an operation of performing box selection on the image to be edited based on a box selection tool; and the editing region determination module includes:
a first editing region determination unit configured to determine a target position of the region coordinates in the map to be edited, and determine the editing region based on the target position; and/or
a second editing region determination unit configured to use a start position of the box selection tool in the map to be edited as a first coordinate of the editing region, use an end position of the box selection tool in the map to be edited as a second coordinate of the editing region, and determine the editing region based on the first coordinate and the second coordinate.

On the basis of the above technical solutions, the editing region is displayed distinctly in the map to be edited, and at least one grid located in the editing region is adjusted to be in an editable state.

On the basis of the above technical solutions, the target map determination module includes:
a data content editing unit configured to, in response to that the grid is in an editable state, edit a grid attribute of the grid to fill data content corresponding to the grid type; and
a target map determination unit configured to determine the target map based on the editing information of each grid in the editing region in response to a target operation.

On the basis of the above technical solutions, the apparatus further includes: a prompt module configured to determine grid data in the editing region to provide a message prompt in response to that a total number of grids reaches a preset quantity threshold.

On the basis of the above technical solutions, the apparatus further includes:
a hash table creation module configured to create at least one hash table based on a grid type of the grid; and
a data content update module configured to update data content in a corresponding hash table based on a grid identifier of each grid and data content corresponding to the grid type.

The task handling apparatus according to an embodiment of the present disclosure can perform the map editing method according to any one of the embodiments of the present disclosure, and has corresponding functional modules and beneficial effects for performing the method.

It should be noted that division of the units and modules included in the above apparatus is merely based on functional logic, but are not limited to the above division, provided that corresponding functions can be implemented. In addition, specific names of the functional units are merely used for ease of distinction and are not intended to limit the protection scope of the embodiments of the present disclosure.

FIG. 7 is a schematic diagram of a structure of an electronic device according to an embodiment of the present disclosure. FIG. 7 is a schematic diagram of a structure of an electronic device (for example, a terminal device or a server in FIG. 7) 400 suitable for implementing the embodiments of the present disclosure. The terminal device in this embodiment of the present disclosure may include but is not limited to mobile terminals such as a mobile phone, a notebook computer, a digital audio broadcasting receiver, a personal digital assistant (PDA), a tablet computer (PAD), a portable multimedia player (PMP), and a vehicle-mounted terminal (for example, a vehicle-mounted navigation terminal) and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device 400 may include a processing apparatus (e.g., a central processing unit or a graphics processing unit) 401 that may perform a variety of appropriate actions and processing in accordance with a program stored in a read-only memory (ROM) 402 or a program loaded from a storage apparatus 408 into a random access memory (RAM) 403. The RAM 403 further stores various programs and data required for the operation of the electronic device 400. The processing apparatus 401, the ROM 402, and the RAM 403 are connected to each other through a bus 404. An input/output (I/O) interface 405 is also connected to the bus 404.

Generally, the following apparatuses may be connected to the I/O interface 405: an input apparatus 406 including, for example, a touchscreen, a touchpad, a keyboard, a mouse, a camera, a microphone, an accelerometer, and a gyroscope; an output apparatus 407 including, for example, a liquid crystal display (LCD), a speaker, and a vibrator; the storage apparatus 408 including, for example, a tape and a hard disk; and a communication apparatus 409. The communication apparatus 409 may allow the electronic device 400 to perform wireless or wired communication with other devices to exchange data. Although FIG. 7 shows the electronic device 400 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such a setting, the computer program may be downloaded from a network through the communication apparatus 409 and installed, installed from the storage apparatus 408, or installed from the ROM 402. When the computer program is executed by the processing apparatus 401, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the map editing method according to the above embodiments belong to the same inventive concept. For the technical details not exhaustively described in this embodiment, reference may be made to the above embodiments, and this embodiment and the above embodiments have the same beneficial effects.

The embodiments of the present disclosure provides a computer storage medium having stored thereon a computer program that, when executed by a processor, causes the map editing method provided in the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
display a map to be edited in response to a map display operation;
convert a grid map corresponding to the map to be edited into an image to be edited in a preset format in response to a trigger operation for a target control;
determine, in response to an editing operation for the image to be edited, an editing region of the editing operation in the map to be edited; and
determine a target map corresponding to the map to be edited based on editing information of each grid in the editing region.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, [Example 1] provides a map editing method. The method includes:
displaying a map to be edited in response to a map display operation;
converting a grid map corresponding to the map to be edited into an image to be edited in a preset format in response to a trigger operation for a target control;
determining, in response to an editing operation for the image to be edited, an editing region of the editing operation in the map to be edited; and
determining a target map corresponding to the map to be edited based on editing information of each grid in the editing region.

According to one or more embodiments of the present disclosure, [Example 2] provides a map editing method. The method further includes:

Optionally, the converting a grid map corresponding to the map to be edited into an image to be edited in a preset format in response to a trigger operation for a target control includes:
in response to that the trigger operation for the target control is detected, creating the grid map corresponding to the map to be edited, and processing the grid map into the preset format; and
using the grid map converted into the preset format as a background image of the map to be edited, to obtain the image to be edited.

According to one or more embodiments of the present disclosure, [Example 3] provides a map editing method. The method further includes:

Optionally, the grid map includes at least one grid, and a grid attribute of the at least one grid includes a grid type of the grid.

According to one or more embodiments of the present disclosure, [Example 4] provides a map editing method. The method further includes:
optionally, displaying the grid map based on a preset transparency, such that at least one grid in the grid map is in an invisible state.

According to one or more embodiments of the present disclosure, [Example 5] provides a map editing method. The method further includes:

Optionally, the editing operation includes an operation of editing a region coordinate in a region selection control and/or an operation of performing box selection on the image to be edited based on a box selection tool, and determining the editing region of the editing operation in the map to be edited includes:
determining a target position of the region coordinates in the map to be edited, and determining the editing region based on the target position; and/or
using a start position of the box selection tool in the map to be edited as first coordinate of the editing region, using an end position of the box selection tool in the map to be edited as second coordinate of the editing region, and determining the editing region based on the first coordinate and the second coordinate.

According to one or more embodiments of the present disclosure, [Example 6] provides a map editing method. The method further includes:

Optionally, the editing region is displayed distinctly in the map to be edited, and at least one grid located in the editing region is adjusted to be in an editable state.

According to one or more embodiments of the present disclosure, [Example 7] provides a map editing method. The method further includes:

Optionally, determining the target map corresponding to the map to be edited based on editing information of each grid in the editing region includes:
in response to that the grid is in an editable state, editing a grid attribute of the grid to fill a data content corresponding to the grid type; and
determining the target map based on the editing information of the each grid in the editing region in response to a target operation.

According to one or more embodiments of the present disclosure, [Example 8] provides a map editing method. The method further includes:

Optionally, in a process of determining the editing region, the method further includes:
determining grid data in the editing region to provide a message prompt in response to that a total number of grids reaches a preset quantity threshold.

According to one or more embodiments of the present disclosure, [Example 9] provides a map editing method. The method further includes:
optionally, creating at least one hash table based on a grid type of the grid; and
updating a data content in a corresponding hash table based on a grid identifier of each grid and a data content corresponding to the grid type.

According to one or more embodiments of the present disclosure, [Example 10] provides a map editing apparatus. The apparatus includes:
a map-to-be-edited display module configured to display a map to be edited in response to a map display operation;
an image-to-be-edited display module configured to convert a grid map corresponding to the map to be edited into an image to be edited in a preset format in response to a trigger operation for a target control, where the image data includes the map to be edited;
an editing region determination module configured to determine, in response to an editing operation for the image to be edited, an editing region of the editing operation in the map to be edited; and
a target map determination module configured to determine a target map corresponding to the map to be edited based on editing information of each grid in the editing region.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A map editing method, comprising:
displaying a map to be edited in response to a map display operation;
converting a grid map corresponding to the map to be edited into an image to be edited in a preset format in response to a trigger operation for a target control;
determining, in response to an editing operation for the image to be edited, an editing region of the editing operation in the map to be edited; and
determining a target map corresponding to the map to be edited based on editing information of each grid in the editing region.

2. The method according to claim 1, wherein converting the grid map corresponding to the map to be edited into the image to be edited in the preset format in response to the trigger operation for the target control comprises:
in response to that the trigger operation for the target control is detected, creating the grid map corresponding to the map to be edited, and processing the grid map into the preset format; and
using the grid map converted into the preset format as a background image of the map to be edited, to obtain the image to be edited.

3. The method according to claim 1, wherein the grid map comprises at least one grid, and a grid attribute of the at least one grid comprises a grid type of the grid.

4. The method according to claim 2, wherein the method further comprises:
displaying the grid map based on a preset transparency, such that at least one grid in the grid map is in an invisible state.

5. The method according to claim 1, wherein the editing operation comprises an operation of editing a region coordinate in a region selection control and/or an operation of performing a box selection on the image to be edited based on a box selection tool, and determining the editing region of the editing operation in the map to be edited comprises:
determining a target position of the region coordinate in the map to be edited, and determining the editing region based on the target position; and/or
using a start position of the box selection tool in the map to be edited as a first coordinate of the editing region, using an end position of the box selection tool in the map to be edited as a second coordinate of the editing region, and determining the editing region based on the first coordinate and the second coordinate.

6. The method according to claim 1, wherein the editing region is displayed distinctly in the map to be edited, and at least one grid located in the editing region is adjusted to be in an editable state.

7. The method according to claim 1, wherein the determining the target map corresponding to the map to be edited based on the editing information of each grid in the editing region comprises:
in response to that the grid is in an editable state, editing a grid attribute of the grid to fill a data content corresponding to a grid type of the grid; and
determining the target map based on the editing information of the each grid in the editing region in response to a target operation.

8. The method according to claim 1, wherein in a process of determining the editing region, the method further comprises:
determining grid data in the editing region to provide a message prompt in response to that a total number of grids reaches a preset quantity threshold.

9. The method according to claim 1, wherein the method further comprises:
creating at least one hash table based on a grid type of the grid; and
updating a data content in a corresponding hash table based on a grid identifier of each grid and a data content corresponding to the grid type.

10. The method according to claim 3, wherein the grid attribute comprises a grid type of the grid, and the grid type comprises a passable type, a non-passable type, a wait point type, and a non-wait point type.

11. The method according to claim 9, wherein the grid types in grid attributes corresponding to different grids are different, and a hash table corresponding to each grid type is created.

12. The method according to claim 11, wherein the grid types comprises a passable grid type, a non-passable grid type, a wait point grid type, and a non-wait point grid type, and hash tables are created based on different grid types.

13. The method according to claim 2, wherein the grid map comprises at least one grid, and a grid attribute of the at least one grid comprises a grid type of the grid.

14. The method according to claim 5, wherein the editing region is displayed distinctly in the map to be edited, and at least one grid located in the editing region is adjusted to be in an editable state.

15. An electronic device, comprising:
one or more processors; and
a storage apparatus configured to store one or more programs, wherein
upon the one or more programs being executed by the one or more processors, a map editing method is implemented by the one or more processors; and
the map editing method comprises:
displaying a map to be edited in response to a map display operation;
converting a grid map corresponding to the map to be edited into an image to be edited in a preset format in response to a trigger operation for a target control;
determining, in response to an editing operation for the image to be edited, an editing region of the editing operation in the map to be edited; and
determining a target map corresponding to the map to be edited based on editing information of each grid in the editing region.

16. The electronic device according to claim 15, wherein the grid map comprises at least one grid, and a grid attribute of the at least one grid comprises a grid type of the grid.

17. The electronic device according to claim 15, wherein the editing operation comprises an operation of editing a region coordinate in a region selection control and/or an operation of performing a box selection on the image to be edited based on a box selection tool, and determining the editing region of the editing operation in the map to be edited comprises:
determining a target position of the region coordinate in the map to be edited, and determining the editing region based on the target position; and/or
using a start position of the box selection tool in the map to be edited as a first coordinate of the editing region, using an end position of the box selection tool in the map to be edited as a second coordinate of the editing region, and determining the editing region based on the first coordinate and the second coordinate;
the editing region is displayed distinctly in the map to be edited, and at least one grid located in the editing region is adjusted to be in an editable state.

18. The electronic device according to claim 15, wherein converting the grid map corresponding to the map to be edited into the image to be edited in the preset format in response to the trigger operation for the target control comprises:
in response to that the trigger operation for the target control is detected, creating the grid map corresponding to the map to be edited, and processing the grid map into the preset format;
using the grid map converted into the preset format as a background image of the map to be edited, to obtain the image to be edited; and
the grid map comprises at least one grid, and a grid attribute of the at least one grid comprises a grid type of the grid.

19. The electronic device according to claim 15, wherein the grid map comprises at least one grid, and a grid attribute of the at least one grid comprises a grid type of the grid; and
the grid attribute comprises a grid type of the grid, and the grid type comprises a passable type, a non-passable type, a wait point type, and a non-wait point type.

20. A storage medium containing computer-executable instructions, wherein the computer-executable instructions, when executed by a computer processor, are used to perform a map editing method; and
the map editing method comprises:
displaying a map to be edited in response to a map display operation;
converting a grid map corresponding to the map to be edited into an image to be edited in a preset format in response to a trigger operation for a target control;
determining, in response to an editing operation for the image to be edited, an editing region of the editing operation in the map to be edited; and
determining a target map corresponding to the map to be edited based on editing information of each grid in the editing region.
